(19) United States
(12) Patent Application Publication
(10) Pub. No.: US 2005/0041435 A1
(43) Pub. Date: Feb. 24, 2005

(54) Vehicle infra-red light source for an infra-red night vision system

(76) Inventor: Joerg Moisel, Neu-Ulm (DE)

Correspondence Address: PENDORF & CUTLIFF, 5111 MEMORIAL HIGHWAY, TAMPA, FL, 33634-7356, US

(21) Appl. No.: 10/922,498

(22) Filed: Aug. 20, 2004

(30) Foreign Application Priority Data
Aug. 20, 2003 (DE) 103 38 923.7
Oct. 16, 2003 (DE) 103 48 117.6-31

(51) Int. Cl. G02F 1/01

(52) U.S. Cl. 362/459

(57) ABSTRACT

The invention relates to a vehicle infrared radiation source having a plurality of infrared LEDs, a significant number, or all of the infrared LEDs of which, are removed from the vehicle light system and are arranged distributed over a large surface of typically more than 20×20 cm. The infrared LEDs which are preferably arranged at a distance from one another are arranged in the region of the vehicle windows, the radiator grille, or the bumpers, or vehicle aprons, at a significant distance from the vehicle light system, in particular from the headlights, the foglights, the reversing lights. Distributing the removed infrared LEDs over a large surface ensures that the infrared radiation source ensures sufficient safety for the eyes, thus largely excluding the possibility of damage to the eyes of other road users. The infrared radiation source according to the invention proves to be an advantageous component of an infrared night vision device which ensures that visibility is improved even in darkness or poor visibility conditions.

### BACKGROUND OF THE INVENTION

1. Field of the Invention

The invention relates to a vehicle infrared radiation source for an infrared night vision system and to an infrared night vision system.

In Rule No. ECE 48; Enheitliche Bedingungen für die Genehmigung der Fahrzeuge hinsichtlich des Anbaus der Beleuchtungs- und Lichtsignaleinrichtungen [Standard Conditions for the approval of Vehicles with respect to the Installation of Lighting and Light Signal Devices]; BGB1 II, 1995, No. 32, Appendix volume, pages 1 to 56, the requirements for approval of a vehicle light system are presented. In this Rule, it is defined, for example, where vehicle headlights can be arranged on the vehicle and what shape a conical beam of light of a vehicle headlight must have. As a supplement to this Rule for the vehicle light system, there are additionally the specifications of the German Road Traffic Licensing Authority paragraph 50 et seq.

2. Related Art of the Invention

European Patent Application EP 1 191 279 A2 discloses a light source for a vehicle which emits both visible light and infrared radiation. This embodiment of this vehicle headlight ensures that damage to the retina of the eye of a road user by the infrared radiation of the headlight is largely prevented since the intensive infrared radiation is emitted together with visible light and the visible light causes the road user to be dazzled, so that he turns away his head or an eyelid closing reflex is brought about which prevents the infrared radiation from striking the sensitive retina.

DIN 5031 discloses that visible light constitutes electromagnetic radiation with a wavelength between 380 nm and 780 nm and as such it can be sensed by the eye and perceived as coloured light. In contrast, infrared radiation is basically understood only to be electromagnetic radiation with a wavelength above 780 nm. This infrared radiation is generally not perceived by the eye as a coloured optical impression so that intensive infrared radiation can constitute a hazard for the retina, for example.

### SUMMARY OF THE INVENTION

The object of the invention is to specify an infrared radiation source for a vehicle which is suitable to be used for an infrared night vision system and which keeps the risk for the eye of a road user low. A further object of the invention is to specify an infrared night vision system whose infrared radiation source and thus the infrared night vision system, largely prevents any hazard for the eye.

These objects are achieved by means of a vehicle infrared radiation source having the features of Claim 1 and an infrared night vision system for a vehicle having the features of Claim 14.

Advantageous developments of the invention are the subject-matter of the subclaims.

The invention relates to a vehicle infrared radiation source, that is to say a radiation source for infrared radiation having a wavelength >780 nm, that is to say not a source of visible light. This vehicle infrared radiation source exhibits a plurality of infrared LEDs, at least a significant number of which are removed from the vehicle light system and are thus not a component of the vehicle light system, for example of the front headlights or tail lights or are connected thereto. The removed infrared LEDs are arranged on the vehicle distributed over a surface. The surface typically exhibits an extent of more than 10 cm×10 cm, or a maximum extent of more than 15 cm. In an exceptional case, relatively small extents of the surface are also possible. Arranging the infrared LEDs over a considerable surface in this way ensures that the infrared radiation which is emitted by the infrared LEDs is not so concentrated that it can bring about damage to the eyes, in particular the retina of road users. In contrast, the radiation which is emitted is overall sufficient for the surroundings of the vehicle to be irradiated by infrared radiation so that the infrared radiation which is reflected from the surroundings can be sensed by an infrared sensitive camera and can be made available to the driver of a vehicle after optional conditioning of the image data. By using this infrared night vision system with the described vehicle infrared radiation source according to the invention, it becomes possible, on the one hand, to bring about reliable and effective irradiation of the surroundings of the vehicle by infrared radiation and, where necessary, to represent the irradiated surroundings to the vehicle driver in a safe and reliable fashion and thus make them available to him.

This arrangement on the one hand increases the traffic safety for the vehicle driver by enabling him to perceive the surroundings more safely and better even under difficult conditions, for example at night or in fog. On the other hand, the danger to other road users is reduced or largely eliminated by reducing the risk of damage by the infrared radiation. This is brought about by the particular arrangement of the infrared LEDs respectively by distributing the infrared LEDs over a considerable surface.

It has proven particularly effective here for a significant number of the infrared LEDs which are arranged at a distance from the vehicle light system, in particular from the headlights, the foglights, the reversing lights, the tail lights, to be spaced apart from the vehicle light system, in particular at a distance which is greater than the dimension of the closest part of the vehicle light system. As a result of this embodiment it is possible to reliably separate the infrared radiation from the visible light and to separate the individual sources of visible light on the one hand, and of infrared radiation on the other, from one another in a safe and optimum fashion and to embody them in an optimum way for their respective requirements. For example, it has proven effective to make the light sources small and compact in terms of their opening diameter, which is made possible to a particular degree especially by the xenon headlights, whereas it has in fact proven effective according to the invention to arrange the infrared LEDS or a significant number of the infrared LEDs distributed over a considerable, relatively large surface of the vehicle. This permits the various sources to be arranged in an optimized way.

One particularly preferred embodiment of the vehicle infrared radiation source according to the invention shows that the infrared LEDs, or a significant number thereof, are connected to the bodywork of the vehicle in planar fashion. This brings about reliable mechanical coupling of the infrared LEDs so that they cannot be destroyed, or their function adversely affected, even under very difficult conditions such as occur, for example, as a result of the vibrations when the vehicle is operating. It has proven particularly effective here for the infrared LEDS not only to be coupled in a mechanical, planar fashion but also to ensure, in addition to this mechanical coupling, thermal coupling, as a result of which the waste heat of the infrared LEDS which occurs when the infrared LEDs are operating, can be reliably transferred to the bodywork of the vehicle and as a result, the durability of the infrared LEDs can be significantly increased. Furthermore, this thermal coupling allows the operation of the infrared LEDs to be kept in a particularly preferred temperature range, as a result of which the emission properties of the infrared radiation source, or of the infrared LEDs, can be adjusted very specifically and precisely.

According to a further preferred embodiment of the invention, some or all of the infrared LEDs are arranged in a depression in the bodywork of the vehicle. This arrangement ensures that the infrared LEDs do not project, or project to only a slight degree, above the bodywork of the vehicle and as a result are subject to a considerably smaller degree to the influences of the surroundings, for example, due to wind, rain and storms or even snow. This arrangement in depressions, for examples in grooves or in gaps or in regions of adjoining pieces of sheet metal of the bodywork, makes it possible, on the one hand, to ensure the mechanical protection of the infrared LEDS and, on the other hand, to prevent the functional capability of the infrared LEDs from being restricted, or to restrict it only to a slight degree. In this arrangement, it has proven particularly advantageous to use housed LEDs since these have proven particularly resistant and, despite their extent, can be safely accommodated in the bodywork.

A significant number of the infrared LEDS are preferably arranged in the region of the vehicle windows, the radiator grille, the bumpers or the vehicle aprons. It has proven particularly effective to embody these infrared LEDS not only as the housed variant, but also as non-housed LEDs and to connect them directly to the bodywork of the vehicle. This arrangement of the infrared LEDs in the region of the vehicle windows, the radiator grille, the bumpers or the aprons makes it possible to illuminate the vehicle surroundings reliably with infrared radiation since these bodywork parts are on the one hand, essentially planar in design and on the other hand, have an orientation which is directed to the front, to the side or to the rear with respect to the vehicle, thus permitting simple and effective illumination of the surroundings of the vehicle.

It has proven particularly effective to arrange the infrared LEDs in the region of the vehicle window, in particular in the region of the frame or of the A pillar or C pillar or in or on the vehicle window. This position makes it possible, on the one hand, to illuminate the surroundings reliably owing to the elevated position in the bodywork of the vehicle and on the other hand permits a secure mechanical connection of the infrared LEDs since the materials used, in particular of the vehicle window, permit the infrared LEDs to be attached effectively. For example, the vehicle windows can easily be coated in terms of fabrication technology with such infrared LEDS during the manufacturing process of the vehicle windows. In addition it has proven particularly effective to arrange the infrared LEDS in the region of the vehicle aprons or in the radiator grille, which also permits the region in front of or behind the vehicle to be illuminated reliably and to a particular degree benefits from the fact that these parts of the vehicle bodywork essentially exhibit a less inclined orientation and thus permit the surroundings to be illuminated easily or permit complex additional inclination elements. When arranging the infrared LEDS in the region of the vehicle aprons or of the radiator grille, it has proven effective to take precautions which allow the infrared LEDs to be cleaned of soiling when necessary. This can be carried out, for example, by mechanical wiping or else by spraying with a cleaning fluid, for example, by means of water.

It has proven particularly advantageous to arrange at least some of the infrared LEDS at a distance from one another so that there is no resulting coherent arrangement of the infrared LEDs which, for a road user, would have the effect of a coherent large infrared source such as can be produced, for example, due to infrared LEDS which are combined to form an array without any spacing. According to the invention, the spatial distribution over a relatively large surface, in particular the spacing apart of the individual LEDs, actually ensures that the road users are not put at risk from excessively high infrared radiation. It has proven particularly effective here to space the infrared LEDS apart in such a way that the distance is larger than their dimensioning or a multiple thereof.

In addition, it has proven effective to combine some or even all of the infrared LEDs into groups with a small number of infrared LEDS and to arrange these groups at a distance from one another. It has proven effective here to embody the groups with a number of less than 100 infrared LEDs, in particular typically in the range of 10 to 30 LEDs, which particularly ensures that a local, potentially damaging infrared radiation strength is not exceeded. By combining individual infrared LEDs into groups it is possible to significantly reduce the effort on control and power supply, which significantly reduces the handling, the susceptibility and the costs of the vehicle infrared radiation source. It has proven particularly effective here to arrange the individual groups on different vehicle components, for example underneath or to the side of or above the vehicle window, in particular front windscreen and/or the radiator grille and/or the front apron. This differentiated arrangement of the groups ensures it is possible to irradiate the surroundings of the vehicle with infrared radiation in a comprehensive and effective fashion.

It has proven very advantageous to embody the vehicle infrared radiation source according to the invention in such a way that lines are provided for actuating or supplying power to the infrared LEDs, said lines being at least partially or else even all embodied so as to extend in the bodywork. This embodiment ensures that the power supply and the actuation are ensured even under difficult external circumstances. The bodywork represents a mechanical or else chemical protection for the lines and thus ensures the functional capability of the infrared radiation source of the vehicle. This ensures that even difficult external circumstances such as, for example, rain, acidic or alkaline solvents, for example from washing systems, do not have any significant influence on the functional capability and durability of the functional capability of the vehicle infrared radiation source. The control line is preferably embodied so as to extend in the bodywork in a way which is at least partially invisible. This can be done, for example, by arranging the lines underneath the coloured layer of the surface coating or else making them transparent so that, when the vehicle is viewed with the vehicle infrared radiation source according to the invention, the control lines and power supply lines for the infrared LEDs can be seen only to a limited degree or cannot be seen at all.

As a result it is possible to prevent the aesthetic impression of the vehicle being significantly adversely affected by the line. Moreover, as a result of an arrangement between the coloured layer and the carrier of the part of the bodywork, for example, in the form of a piece of sheet metal or a plastic carrier, it is ensured that a safe and protected arrangement is provided without a negative aesthetic effect. In this context, this type of arrangement has proven particularly effective as a result of the possibility of easily integrating it into the fabrication process or surface coating process of the part of the bodywork or of the vehicle as a whole.

The embodiment of the line, in particular of the control lines, as transparent lines is brought about, for example, by applying the lines in the form of thin metal foils or metal-containing foils, formed for example from indium tin oxide. By using the suitable electrically conductive, in particular metallic materials in conjunction with the selected material thickness, it is possible to implement largely invisible or completely transparent lines, in particular for the control lines or else for supply lines. These transparent lines can also be arranged between the coloured layer and the transparent covering layer of the surface coating system and can also be applied at a later time in the surface coating process, which notably improves the handleability in the fabrication process.

It has proven particularly advantageous to provide one or more control devices for actuating the infrared LEDs. These control devices are removed from the vehicle light system and arranged in particular in the region of the infrared LEDs, preferably in the region of infrared LEDs which are combined to form groups. This embodiment permits the length of the control lines to be significantly reduced so that the effort involved in fabricating and handling the infrared radiation source is significantly improved. The control devices are preferably embodied here in such a way that they can be arranged in the region of depressions in the bodywork so that they can be integrated optically or even mechanically into the shape of the bodywork together with the infrared LEDS, thus being provided with optical and mechanical protection. In these depressions, the forces of the surroundings do not act in such a way, in particular at high speeds of the slipstream, on the components of the vehicle infrared radiation source, in particular on the infrared LEDs or on the control devices, so that, on the one hand the latter ensure effective irradiation of the surroundings. This is also made possible here over a relatively long time period even under difficult external conditions.

It has proven particularly effective here to implement this control device in the form of foil circuits which include very flat, integrated circuits, for example in the form of bonded dies which have only a low height and can thus be very easily accommodated in the bodywork, in particular in depressions or else in the surface coating layer or between the surface coating and the carrier of the part of the bodywork. Furthermore, it has proven particularly effective to arrange the control device in the region of individual groups of infrared LEDs so that the individual control lines from the control device to the infrared LEDs assigned to it can be kept very short. This permits a very compact and modular implementation of the groups with assigned control device. These groups with control devices can, if appropriate, be arranged on a common foil carrier which can be manufactured in a modular fashion and applied, for example, to a part of the bodywork such as the engine bonnet or the A pillar and mechanically and chemically protected in particular within the frame of the surface coating, at least by the transparent covering surface coating. This results in vehicle infrared radiation sources which are very easy to implement and can be manufactured cost-effectively in terms of fabrication technology.

It has proven particularly advantageous to embody the control device in such a way that the infrared LEDs of the vehicle infrared radiation source can be actuated in a differentiated fashion. This is preferably carried out in such a way that groups of infrared LEDS of the vehicle infrared radiation source which can be switched on and off in a fashion which is differentiated in particular as a function of speed are formed. For example, it has proven particularly effective at relatively high speeds of the vehicle to activate a group of infrared LEDs which irradiates the region of the vehicle with infrared light at a relatively large distance from the vehicle, in particular in front of it. This group of infrared LEDS can be activated in addition to the activation of other infrared LEDs which has already taken place, but also as an alternative thereto.

In this context, the groups of infrared LEDs can be differentiated from the others, on the one hand, through a differentiated embodiment of the individual infrared LEDs, for example through specific wide-beam characteristics, and can generate a specific variable beam characteristic by selective activation of this group. This can be brought about, for example, by means of optical elements which are assigned to individual infrared LEDS, but also through a specific orientation of individual infrared LEDs and thus of the arrangement on the vehicle. In this context, the infrared LEDS of the individual groups can be separated from one another but also arranged or mounted in combination on the vehicle. It has proven particularly effective to arrange the individual groups separately, which groups can be activated or deactivated in a differentiated fashion, for example as a function of speed and/or as a function of weather and/or of the external conditions. Here, these external or vehicle-specific situations are sensed by corresponding sensors and the information relating to the particular situation is fed to the control device in order to actuate the infrared LEDs.

Furthermore, it has proven particularly effective to implement the infrared LEDs as vertical laser diodes, also referred to as VCL diodes or VCSEL diodes. This type of infrared LEDs prove particularly advantageous since they primarily, or virtually exclusively, emit vertical infrared radiation and as a result emit infrared radiation in a way which is very selective with respect to direction so that the type of installation and the orientation during installation can bring about very selectively determined radiation characteristics of the vehicle infrared radiation source.

It has proven particularly effective to embody the infrared LEDs in such a way that they emit exclusively infrared radiation with a wavelength above 780 nm, in particular above 830 nm. This ensures that a road user cannot receive any visible colour impression at all. It is also ensured that no disruptive effect as a result of a reddish haze or reddish shimmering impression as a result of the infrared LEDS can also be produced in the front region of the vehicle which is provided with the infrared radiation source according to the invention, which effect could lead to a misinterpretation as a tail light of the vehicle. Such an incorrect impression owing to a supposedly perceived reddish haze is prevented, according to the invention, on the one hand, by the selection of the infrared LEDs with a very low intrinsic lighting force and by the selection of the emission range of the infrared LEDs, in particular with a wavelength above 830 nm. This leads to a very effective infrared radiation source which permits safe and reliable and also sufficiently high-power irradiation of the surroundings of the vehicle with infrared radiation so that the surroundings reflect the infrared radiation and this reflected infrared radiation is sensed by an infrared-sensitive camera of an infrared night vision device and made available to the vehicle driver directly or after signal conditioning. Furthermore, the infrared radiation source according to the invention ensures that the infrared radiation source is not misinterpreted as a red tail light. This is ensured on the one hand by the low individual transmission power of the infrared LEDs and by their distributed arrangement, as well as by the selection of the emission range.

In addition to the embodiment of a vehicle infrared radiation source, the invention also relates to an infrared night vision system for a vehicle with a vehicle infrared radiation source such as is described above. Such an infrared night vision system proves very reliable during operation, in particular in terms of misinterpretations. This makes the vehicle with such an infrared night vision system very safe during operation since it leads on the one hand to an improvement in vision and thus to a reduction in vehicle accidents, and on the other hand, makes available this property available over a very long time period and in a very reliable way.

### BRIEF DESCRIPTIONS OF THE DRAWINGS

The invention is explained below with reference to a preferred exemplary embodiment of the invention which is illustrated in three figures:

FIG. 1 shows a vehicle in a front view with an infrared night vision system according to the invention and with two vehicle infrared radiation sources according to the invention,

FIG. 2 shows the schematic structure of a vehicle infrared radiation source according to the invention, and

FIG. 3 shows a way of integrating an infrared LED of a vehicle infrared radiation source according to the invention into a part of the bodywork.

### DETAILED DESCRIPTION OF THE INVENTION

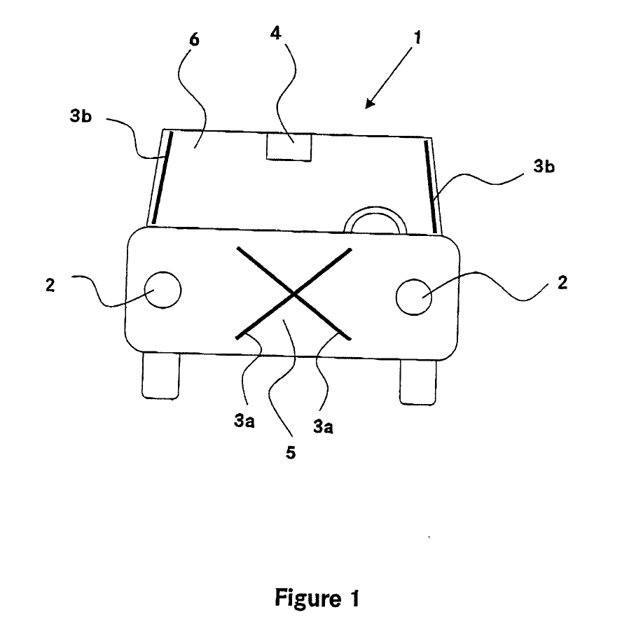

FIG. 1 is a schematic view of a vehicle 1 from the front, that is to say from the direction of travel. The vehicle 1 exhibits two vehicle headlights 2 which throw the dipped light or main beam light of the vehicle 1 into the area in front of the vehicle 1. The dipped light or main beam light constitutes visible light of a wavelength between 380 and 780 nm. The radiator grille 5 is arranged between the two headlights 2. An arrangement 3a composed of a plurality of infrared LEDs is arranged on the radiator grille. This arrangement 3a constitutes a cruciform arrangement composed of a plurality of infrared LEDS which are distributed on two lines. Here, the infrared LEDs of the arrangement 3a are implemented as housed LEDS which are arranged in such a way that they safely irradiate the area in front of the vehicle 1 with infrared radiation, i.e. with a wavelength above 830 nm. The cruciform arrangement 3a in or on the radiator grille 5a ensures a safe, high-power irradiation of the surroundings in front of the vehicle 1. It is ensured that the infrared radiation which is reflected from the surroundings can be reliably sensed by the camera 4 which is arranged in the interior of the vehicle. The reflected and sensed infrared irradiation is represented as a video image in a display, which is located in the region of the tachometer, and thus made available to the driver of the vehicle 1. As a result, the driver is enabled to steer the vehicle safely even at night or under poor weather conditions using the infrared night vision system which is essentially composed of the infrared radiation source 3a, the infrared-sensitive camera 4 and the display (not illustrated). The infrared night vision system shown permits improved vision of the surroundings and thus makes a significant contribution to increasing the vehicle safety and to preventing accidents.

The infrared LEDs of the arrangement 3a are distributed here over a surface of approximately 60×30 cm so that the infrared radiation emitted by the infrared LEDs is not likely to damage the eyes or the retina of the eyes of another road user, for example, a pedestrian, who is located in front of the vehicle, for example in the region of a pedestrian crossing. This distribution over a very large area of the infrared LEDs which are in themselves low in power largely prevents any hazard for other road users.

This arrangement 3a is characterized by the fact that it, or its infrared LEDS, is/are at a significant distance from the light system of the vehicle 1 and from the headlights 2 of the vehicle 1. This prevents mutual influencing, and reliable information about the surroundings is provided by reference to the sensed reflected infrared radiation.

The distance between the arrangement 3a and the light system is significantly larger here, in particular larger than three times the dimension of the headlights 2.

In addition to the arrangement 3a, the vehicle 1 is provided with a further arrangement 3b composed of infrared LEDs. This arrangement 3b is arranged in the form of two rows, combined to form a line, in the two A pillars, that is to say on the right hand and left hand sides of the vehicle window. This arrangement of the infrared radiation source 3b makes it possible to irradiate the surroundings of the vehicle in a differentiated way in comparison with the infrared radiation source 3a. While the infrared radiation source 3a essentially irradiates the area in front of the vehicle, the infrared radiation source 3b irradiates both to the front and to the side. The combination of the two infrared radiation sources 3a, 3b ensures a comprehensive, reliable infrared irradiation of the area in front of the vehicle as well as to the right and to the left of the area in front of the vehicle. This common irradiation ensures that the camera 4 can sense a comprehensive representation of the relevant driving area. Here, the two infrared radiation sources 3a, 3b be actuated independently of one another so that, where necessary, only the arrangement 3a is actuated or operated, for example at a high speed, while at low speeds the infrared radiation source 3b is actuated or operated alone or together with the infrared radiation source 3a. Here, the infrared radiation source 3b is formed in the A pillars of the vehicle 1 in such a way that they emit infrared radiation both to the front and to the side. As a result of the very high arrangement in the region of the vehicle window 6 it is possible to implement very reliable and wide-ranging irradiation of the surroundings. This position of the infrared LEDs in the infrared radiation source 3b proves very advantageous.

It has proven particularly advantageous to arrange the infrared LEDs of the infrared radiation source 3b in a groove between the A pillar and the vehicle window 6 of the vehicle 1, where they are mechanically protected. As a result of this arrangement in a depression of the vehicle or of the vehicle bodywork it is possible to operate the infrared radiation source 3b, and thus the infrared night vision device, in a very safe and durable fashion.

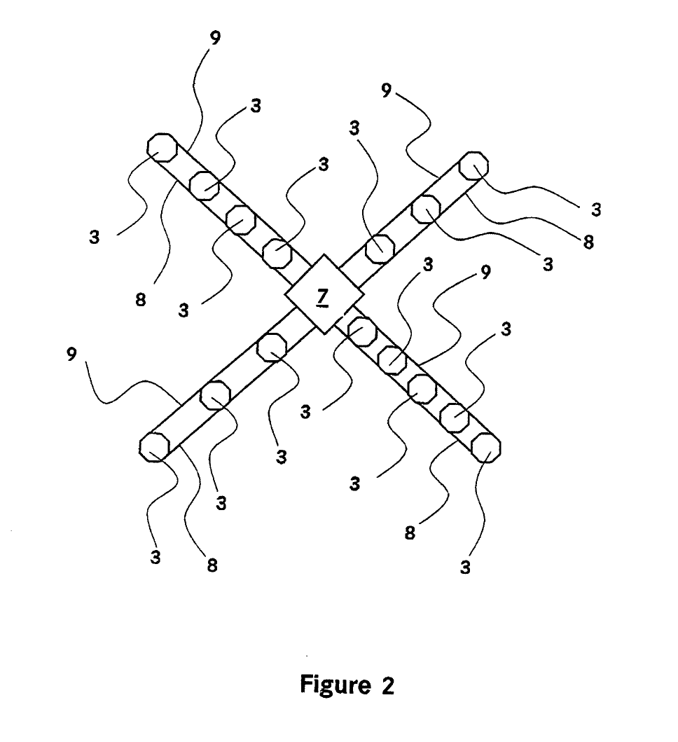

FIG. 2 illustrates the arrangement 3a in more detail. The arrangement 3a exhibits a plurality of individual infrared LEDS 3 which are implemented as housed infrared LEDS. These infrared LEDs 3 are connected to one another via electrical supply lines 8 and control lines 9. The infrared LEDs 3 are arranged on two intersecting lines which have a control device 7 at their point of intersection. The infrared LEDS 3 are actuated with power or with corresponding control signals via the control device 7 so that they can be switched on or off as required. The lines 8, 9 are implemented as electrically conductive lines. They are partially implemented from transparent indium tin oxide. This way of implementing the lines 8, 9 from indium tin oxide is selected in the areas in which the infrared radiation sources 3a could have an adverse effect on the design or on the aesthetic effect of the vehicle, in particular of the radiator grille of the vehicle. By arranging the control unit 7 in the intersection region of the lines 8, 9 and of the infrared LEDS 3 which are combined to form lines it is possible to keep the length of the necessary lines 8, 9 short, and thus keep the costs of such an infrared radiation source or of a corresponding infrared night vision device low. Moreover, such an infrared radiation source 3a also proves very robust since the line length, and thus the risk of damage and thus of malfunction or failure of the infrared radiation source, is markedly reduced. The control unit 7 is actuated in a centralized fashion by a central power supply or by a control signal supply, for example by means of a switch in the passenger compartment of the vehicle.

The embodiment of the control unit 7 makes it possible to use the power supply through the lines 8, 9 jointly, that is to say both for supplying power and for control.

The infrared LEDs of the arrangement 3a form a group of approximately 10 infrared LEDs which are distributed over a considerable surface and thus ensure that an excessively high concentration of the infrared radiation on the retina of a road user is prevented, thus largely ruling out damage to the retina by the emitted infrared radiation. This low number of infrared LEDs which are distributed over this considerable surface of the radiator grille of the vehicle 1 largely rules out the risk of damage to the eyes of a road user.

This is ensured in particular by the fact that the individual infrared LEDs 3 are embodied at a significant distance from one another.

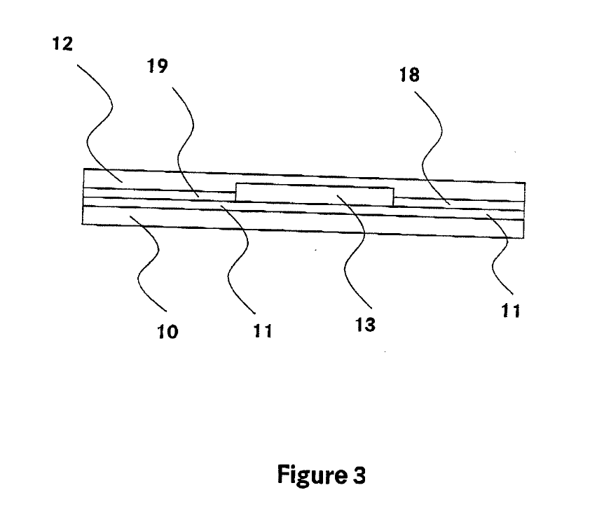

FIG. 3 illustrates an exemplary arrangement of an infrared LED 13 of an infrared radiation source. The infrared LED 13 is integrated into a part of the bodywork, it being arranged between a transparent covering layer 12 and a carrier 10 of the part of the bodywork. The carrier 10 is implemented here as a piece of sheet metal, for example as part of the A pillar of the vehicle 1. The coloured layer 11, which extends over the metallic carrier 10, is arranged between the metallic carrier 10 and the infrared LED. The coloured layer 11 and the transparent covering layer 12 form the surface coating of the part of the bodywork. The coloured layer 11 is embodied here in the region of the infrared LED 13 in such a way that there is good thermal coupling between the infrared LED 13 and the metallic carrier 10. This good thermal coupling which is embodied in a planar fashion, ensures that the waste heat, which arises during the conversion and the emission of the electrical power into infrared radiation, is conducted away to the carrier 10, thus protecting the infrared LED 13 against overheating, and thus against destruction. This good thermal coupling significantly increases the service life of the infrared LED 13. This is of particular significance since, as a result of the integration of the infrared LED 13 into the part 10, 11, 12 of the bodywork, it is not possible to replace an individual infrared LED 13 or it is possible only with great effort. The power for operating the infrared LED is fed in via the lines 18. The infrared LED 13 is actuated via the control lines 19 which are applied between the transparent covering layer 12 and the coloured layer 11. The lines 18, 19 are of transparent design. This is brought about by the fact that a very thin, essentially transparent metal foil, which forms the lines, is used. These metallic lines make it possible to provide power and to actuate the infrared LED 13. This is possible without a significant visual degradation or negative effect on the design of the vehicle.

The transparent covering layer 12 is selected and embodied, at least in the region of the infrared LED 13 or in the region of the infrared radiation source, in such a way that it has a high level of transparency, that is to say very low attenuation, for the infrared radiation with a wavelength greater than 830 nm.

This layered design makes it possible to produce the part of the bodywork very reliably and safely since the metallic carrier 10 is firstly provided with the coloured layer 11 and only subsequently, in the state in which they are protected by the coloured layer 11, are the components of the infrared radiation source, for example the lines 18, 19 and the infrared LEDs 13 applied. Subsequently, this arrangement is provided with the transparent covering layer 12. This sequence of fabrication steps ensures a high fabrication quality of the infrared radiation source and of the part of the bodywork.

The infrared LED 13 which is used is preferably used as a die in an unhoused state rather than in a housed state. As a result it is possible to make a selection such that the area of the infrared LED is very small, with the result that the optical effect of the design, i.e. a negative influence on the optical effect, is largely excluded. The unhoused infrared LEDs can be implemented here as individual LEDs or as wafers, composed of a plurality of individual infrared LEDs, for example as a group of a few, for example, six, unhoused infrared LEDs.

1. A vehicle infrared radiation source for an infrared night vision system having a plurality of infrared LEDs, wherein a significant number of the infrared LEDs are removed from the vehicle light system and distributed over a surface.

2. A vehicle infrared radiation source according to claim 1, wherein a significant number of the infrared LEDs are positioned at a distance from the vehicle light system, in particular from a headlight, from a foglight, from a reversing light, from a tail light, in particular at a distance which is greater than the dimension of the nearest part of the vehicle light system.

3. A vehicle infrared radiation source according to claim 1, wherein a significant number of the infrared LEDs are connected, in particular thermally coupled, to the bodywork of the vehicle in a planar fashion.

4. A vehicle infrared radiation source according to claim 1, wherein a significant number of the infrared LEDs are arranged in a depression in the bodywork of the vehicle.

5. A vehicle infrared radiation source according to claim 1, wherein a significant number of the infrared LEDs are arranged in the region of the vehicle windows, the radiator grille, the bumpers, the external mirrors or vehicle aprons.

6. A vehicle infrared radiation source according to claim 1, wherein at least some of the infrared LEDs are arranged individually at a distance from one another.

7. A vehicle infrared radiation source according to claim 1, wherein at least some of the infrared LEDs are combined to form groups with a small number of infrared LEDs, and these groups are arranged spaced apart from one another.

8. A vehicle infrared radiation source according to claim 1, wherein control lines and/or power supply lines are provided which are embodied so as to extend in the bodywork.

9. A vehicle infrared radiation source according to claim 8, wherein control lines and/or power supply lines are embodied so as to extend in the bodywork in an invisible fashion, in particular arranged underneath the coloured layer of the surface coating or embodied in a transparent fashion.

10. A vehicle infrared radiation source according to claim 1, wherein one or more control devices are provided for actuating infrared LEDs, which devices are removed from the vehicle light system and are arranged in particular in the region of the infrared LEDs.

11. A vehicle infrared radiation source according to claim 1, wherein the infrared LEDs exclusively emit infrared radiation with a wavelength above 780 nm, in particular above 830 nm.

12. A vehicle infrared radiation source according to claim 1, wherein at least some of the infrared LEDs are combined into one or more groups which can be actuated selectively by the control device and can be actuated selectively in groups as a function of the driving situation.

13. A vehicle infrared radiation sources according to claim 1, wherein at least some of the infrared LEDs are embodied as vertical laser diodes.

14. A infrared night vision system for a vehicle having a vehicle infrared radiation source according to claim 1.
